(19) United States
(12) Patent Application Publication
(10) Pub. No.: US 2026/0220574 A1
(43) Pub. Date: Jul. 30, 2026

(54) ARTIFICIAL INTELLIGENCE ASSISTED WORKFLOW DESIGN

(71) Applicant: Palantir Technologies Inc., Denver, CO (US)

(72) Inventors: Vincent Falconieri, Montceau-Les-Mines (FR); Lukasz Falandysz, Warszawa (PL); Chinemerem Enumah, London (GB); Christopher McFarland, Paris (FR); Krzysztof Kowalczyk, London (GB)

(21) Appl. No.: 19/195,484

(22) Filed: Apr. 30, 2025

Related U.S. Application Data
(60) Provisional application No. 63/751,059, filed on Jan. 29, 2025.

(51) Int. Cl. G06Q 10/0631; G06F 40/279

(52) U.S. Cl. CPC G06Q 10/06316; G06F 40/279

(57) ABSTRACT

A solution design system optimizes creation of workflows for integration, analysis, and visualization, of data in a data management system. This system includes graphical interfaces and programmatic tools for connecting data sources, defining transformations, and constructing application logic.

### CROSS-REFERENCE TO RELATED APPLICATIONS

This application claims benefit of U.S. Provisional Patent Application No. 63/751,059, filed Jan. 29, 2025, and titled “ARTIFICIAL INTELLIGENCE ASSISTED WORKFLOW DESIGN.” The entire disclosure of each of the above items is hereby made part of this specification as if set forth fully herein and incorporated by reference for all purposes, for that it contains.

Any and all applications for which a foreign or domestic priority claim is identified in the Application Data Sheet as filed with the present application are hereby incorporated by reference under 37 CFR 1.57.

### TECHNICAL FIELD

The present disclosure relates to systems and techniques for data integration, analysis, and visualization. Some examples provide one or more interactive user interfaces by which a user can efficiently, via continued and/or guided human-machine interaction, build a functional workflow that may be compiled into executable code, for example an application, for performing a technical task. Some examples enable optimization in terms of number of processing operations required to perform a workflow for a particular task.

### BACKGROUND

In the rapidly evolving landscape of managing and integrating information, organizations face significant challenges in designing and implementing effective solutions that leverage complex platforms and tools. Traditional methods of solution design often require extensive expertise and familiarity with the intricacies of specific platforms, making it difficult for less experienced users to navigate and utilize these systems efficiently. This complexity is compounded by the continuous evolution of technologies, which can render existing knowledge and practices obsolete, further complicating the solution design process.

### SUMMARY

Existing systems often lack the capability to guide users through the solution design process, resulting in a steep learning curve and increased reliance on trial-and-error or expert intervention. These limitations hinder the ability of organizations to quickly adapt to new requirements and technological advancements. Thus, there is a need for a more intuitive and adaptive approach to solution design that can empower users of varying expertise levels to create robust, scalable, and efficient workflows within management systems. A workflow in this context may comprise a series of steps or tasks that are performed on data to achieve a specific result. The overall process of a workflow can be considered a pipeline, wherein ingested data flows through the pipeline until it produces the specific result, which may comprise any form of output data. The ingested data may comprise any form of data, including, but not limited to, technical data representing measurement(s) performed by one or more sensors of a machine, video data, audio data, data usable by one or more access control systems, data usable by one or more data security systems and/or software vulnerability scanners, to give some examples. The specific result may comprise, in the context of video data, for example, identifying and/or tracking an object in the video data and/or one or more image processing operations. The specific result may comprise, in the context of audio data, one or more audio processing operations, such as filtering, and/or speech to text processing. The specific result may comprise, in the context of data usable by one or more data security systems and/or software vulnerability scanners, indications of one or more vulnerabilities of one or more software applications and/or indications of one or more patches to remedy any such vulnerabilities. The specific result in any such examples may be data for controlling a computer system to perform a downstream task, such as enabling or preventing access to certain applications or data therefor. A workflow can be validated to produce executable instructions, for example of an application, that implements the workflow. Performance of the executable instructions will involve processing operations, which may vary depending on the particular implementation of the workflow.

In various embodiments discussed herein, large amounts of data are automatically and dynamically calculated interactively in response to user inputs, and the calculated data is efficiently and compactly presented to a user by the system. Thus, in some embodiments, the user interfaces described herein are more efficient as compared to previous user interfaces in which data is not dynamically updated and compactly and efficiently presented to the user in response to interactive inputs.

Further, as described herein, the system may be configured and/or designed to generate user interface data useable for rendering the various interactive user interfaces described. The user interface data may be used by the system, and/or another computer system, device, and/or software program (for example, a browser program), to render the interactive user interfaces. The interactive user interfaces may be displayed on, for example, electronic displays (including, for example, touch-enabled displays).

Additionally, it has been noted that design of computer user interfaces that are useable and easily learned by humans is a non-trivial problem for software developers. The various embodiments of interactive and dynamic user interfaces of the present disclosure are the result of significant research, development, improvement, iteration, and testing. This non-trivial development has resulted in the user interfaces described herein which may provide significant cognitive and ergonomic efficiencies and advantages over previous systems. The interactive and dynamic user interfaces include improved human-computer interactions that may provide reduced mental workloads, improved decision-making, reduced work stress, and/or the like, for a user. For example, user interaction with the interactive user interfaces described herein may provide an optimized display of time-varying report-related information and may enable a user to more quickly access, navigate, assess, and digest such information than previous systems.

In some embodiments, data may be presented in graphical representations, such as visual representations, such as charts and graphs, where appropriate, to allow the user to comfortably review the large amount of data and to take advantage of humans'particularly strong pattern recognition abilities related to visual stimuli. In some embodiments, the system may present aggregate quantities, such as totals, counts, and averages. The system may also utilize the information to interpolate or extrapolate, e.g. forecast, future developments.

Further, the interactive and dynamic user interfaces described herein are enabled by innovations in efficient interactions between the user interfaces and underlying systems and components. For example, disclosed herein are improved methods of receiving user inputs, translation and delivery of those inputs to various system components, automatic and dynamic execution of complex processes in response to the input delivery, automatic interaction among various components and processes of the system, and automatic and dynamic updating of the user interfaces. The interactions and presentation of data via the interactive user interfaces described herein may accordingly provide cognitive and ergonomic efficiencies and advantages over previous systems.

Various embodiments of the present disclosure provide improvements to various technologies and technological fields. For example, as described above, existing data storage and processing technology (including, e.g., in memory databases) is limited in various ways (e.g., manual data review is slow, costly, and less detailed; data is too voluminous; etc.), and various embodiments of the disclosure provide significant improvements over such technology. Additionally, various embodiments of the present disclosure are inextricably tied to computer technology. In particular, various embodiments rely on detection of user inputs via graphical user interfaces, calculation of updates to displayed electronic data based on those user inputs, automatic processing of related electronic data, and presentation of the updates to displayed images via interactive graphical user interfaces. Such features and others (e.g., processing and analysis of large amounts of electronic data) are intimately tied to, and enabled by, computer technology, and would not exist except for computer technology. For example, the interactions with displayed data described below in reference to various embodiments cannot reasonably be performed by humans alone, without the computer technology upon which they are implemented. Further, the implementation of the various embodiments of the present disclosure via computer technology enables many of the advantages described herein, including more efficient interaction with, and presentation of, various types of electronic data.

Additional embodiments of the disclosure are described below in reference to the appended claims, which may serve as an additional summary of the disclosure.

In various embodiments, systems and/or computer systems are disclosed that comprise a computer readable storage medium having program instructions embodied therewith, and one or more processors configured to execute the program instructions to cause the one or more processors to perform operations comprising one or more aspects of the above-and/or below-described embodiments (including one or more aspects of the appended claims).

In various embodiments, computer-implemented methods are disclosed in which, by one or more processors executing program instructions, one or more aspects of the above-and/or below-described embodiments (including one or more aspects of the appended claims) are implemented and/or performed.

In various embodiments, computer program products comprising a computer readable storage medium are disclosed, wherein the computer readable storage medium has program instructions embodied therewith, the program instructions executable by one or more processors to cause the one or more processors to perform operations comprising one or more aspects of the above-and/or below-described embodiments (including one or more aspects of the appended claims).

### BRIEF DESCRIPTION OF THE DRAWINGS

FIG. 1 is a block diagram illustrating one example of an embodiment of a solution design system, including an AI module, that interfaces with several data sources and/or other devices, as well as a user via a user application diagramming tool.

FIG. 2 illustrates an example data management system according to some embodiments of the present disclosure.

FIG. 3 is an example user interface that may serve as a starting screen for the solution design tool.

FIG. 4 is an example user interface that provides additional patterns available to the user as a starting point for a customized workflow.

FIG. 5 is an example user interface representing a workflow editing user interface of the application diagramming tool.

FIG. 6 is an example user interface illustrating a pop-up menu that provides next best node suggestions for a dataset component.

FIG. 7 is an example user interface illustrating an example interaction between a user and the Node Auto Filling module.

FIG. 8 is an example of a portion of a relational data model that may be generated based on properties of available components and provided to an LLM as part of a graph-building prompt.

FIG. 9 is an example table of information indicating relationships between a few example components.

FIG. 10 is an example of a portion of an LLM prompt that may be generated as an initial request for information on a workflow graph.

FIG. 11 is an example of a portion of a workflow diagram that may be generated directly from the LLM in response to a prompt from the diagram generation module.

FIG. 12 is an example of a portion of an LLM prompt that may be sent to the LLM in a request for identification of matching patterns.

FIG. 13 is a flowchart illustrating an example method for AI-assisted solution design, performed by a computing system, such as the system in FIG. 1.

FIG. 14 is a block diagram that illustrates an example computer system upon which various embodiments may be implemented.

### DETAILED DESCRIPTION

### Overview

In one embodiment, a “solution design system” (or simply “system” herein) is provided as an integrated development environment within a data management system to enable rapid creation, configuration, and deployment of end-to-end operational workflows. The solution design system may include graphical interfaces and programmatic tools that allow users to connect to one or more data sources, define data transformations, and construct application logic through a series of configuration steps involving a continued and/or guided human-machine interaction process. Users can specify how data should be imported, validated, cleansed, transformed, and/or enriched via a dependency-aware pipeline mechanism. The solution design system also allows for the configuration of branching and version control so that updates to data pipelines or transformation logic can be isolated and tested in parallel before merging into production environments.

In some implementations, the solution design system provides a modular interface that supports the composition of discrete workflow components. Each component may represent a task such as filtering incoming data, joining tables, applying machine-learning algorithms, or triggering external actions through an application programming interface (API). The system may automatically manage dependencies among these components through a directed acyclic graph (DAG) or similar structure. This ensures that upstream processes—such as data cleansing or model training—complete successfully before dependent processes are executed.

The solution design system can further incorporate role-based permissioning, allowing different user groups, such as data engineers, data scientists, and business analysts, to interact with only the parts of the workflow that align with their responsibilities or expertise. Within each workflow, metadata about input datasets, intermediate artifacts, and output results may be stored in a version-controlled catalog. The catalog preserves an immutable record of changes, enabling sophisticated data lineage tracking that can identify the origins of a given output and any transformations applied along the way. If the data management system supports real-time or near-real-time data streams, the solution design system may also orchestrate continuous updates to downstream systems or user dashboards. Overall, the solution design system provides an interface for building, modifying, testing, and deploying advanced data-driven solutions while maintaining consistent governance, provenance, and security controls throughout the lifecycle of each workflow.

In some embodiments, the solution design system includes a structured navigation interface that allows users to efficiently traverse different stages of solution creation and deployment within a unified environment. The navigation system may present a hierarchical layout—such as a side panel or collapsible menu—that organizes key features, tools, and configuration settings into discrete sections. By selecting a section or sub-section, a user can view and modify associated resources, such as data pipelines, application logic, or user access controls, without losing context on their current work.

The navigation interface may dynamically reflect user permissions or roles, displaying certain features—like administrative settings or production deployment options—only to those authorized to access them. It may also allow switching between branches or environments, ensuring that modifications or testing can be isolated in a development space before deployment. In some implementations, a header area or top-level menu provides global search, recent activity views, or quick links to frequently accessed features, thereby streamlining the user experience.

In addition to core solution-building sections, the navigation may include contextual tooltips, inline documentation links, or notifications that guide users through common workflows, such as importing new datasets or configuring external integrations. If errors occur during data transformations or deployment, the navigation interface may highlight, via a user interface, the affected section, enabling users to locate and resolve issues promptly. Overall, this structured navigation system serves as a central hub for orchestrating the creation, configuration, and maintenance of end-to-end solutions, while preserving clarity and control in complex or collaborative projects.

In some embodiments, the solution design system facilitates the creation of an initial process diagram by guiding a user through a series of steps, via continued and/or guided human-machine interaction with a user interface, to define data inputs, transformations, and outputs within a graphical workflow environment. Upon initiating a “new diagram,” the system may present a blank workspace where the user can, via an input mechanism, drag and drop nodes or modules that represent specific operational tasks—such as ingesting data from a source, applying a filter or join transformation, and delivering results to a downstream process without the need to understand underlying code. Each node in the diagram can be further configured via a properties panel or similar interface, allowing users to specify parameters, map fields, or apply logic as needed. Connections between nodes are established through directed edges or lines, which the solution design system interprets to determine the execution order and dependencies among tasks.

Once the diagram is defined, the user can validate the workflow by running a build process or transformation command that compiles the nodes and edges into executable instructions. Any errors in configuration—such as missing parameters or incompatible data types—are surfaced in real time, and the user is prompted to correct the relevant node properties, again via guided human-machine interaction with the user interface. The tutorial may also include a preview function or embedded output panel so that users can visualize intermediate or final results. This approach provides a streamlined method for newcomers to create and operationalize data pipelines, while the underlying solution design system framework manages version control, lineage tracking, and secure access to each node and dataset involved in the diagram.

In some embodiments, the solution design system implements a diagram-based interface for visually modeling and orchestrating data workflows. Each diagram comprises a set of nodes, which represent discrete operations or services (e.g., data ingestion, transformation, enrichment, or output), connected by edges that define the flow of data and the order of execution. The interface may offer a drag-and-drop canvas for adding and rearranging nodes, as well as configuration panels for specifying parameters, resource locations, or custom logic associated with each node.

As users build or modify a diagram, the system manages dependencies automatically, ensuring that all prerequisite nodes complete successfully before triggering subsequent operations. In some implementations, diagrams may be version-controlled and branched, allowing changes to be tested in isolation before merging into production. The solution design system may also provide real-time validation and error-checking, immediately surfacing configuration conflicts or missing dependencies. By combining graphical representations of data processing logic with robust orchestration capabilities, diagrams enable teams to conceptualize and implement complex data pipelines quickly and with minimal risk of misconfiguration.

In order to facilitate an understanding of the systems and methods discussed herein, a number of terms are described below. The terms described below, as well as other terms used herein, should be construed to include the provided descriptions, the ordinary and customary meaning of the terms, and/or any other implied meaning for the respective terms. Thus, the descriptions below do not limit the meaning of these terms, but only provide exemplary descriptions.

Ontology: Stored information that provides a data model for storage of data in one or more databases. For example, the stored data may comprise definitions for data object types and respective associated property types. An ontology may also include respective link types/definitions associated with data object types, which may include indications of how data object types may be related to one another. An ontology may also include respective actions associated with data object types. The actions associated with data object types may include, e.g., defined changes to values of properties based on various inputs. An ontology may also include respective functions, or indications of associated functions, associated with data object types, which functions, e.g., may be executed when a data object of the associated type is accessed. An ontology may constitute a way to represent things in the world. An ontology may be used by an organization to model a view on what objects exist in the world, what their properties are, and how they are related to each other. An ontology may be user-defined, computer-defined, or some combination of the two. An ontology may include hierarchical relationships among data object types.

Data Store: Any computer readable storage medium and/or device (or collection of data storage mediums and/or devices). Examples of data stores include, but are not limited to, optical disks (e.g., CD-ROM, DVD-ROM, etc.), magnetic disks (e.g., hard disks, floppy disks, etc.), memory circuits (e.g., solid state drives, random-access memory (RAM), etc.), and/or the like. Another example of a data store is a hosted storage environment that includes a collection of physical data storage devices that may be remotely accessible and may be rapidly provisioned as needed (commonly referred to as “cloud” storage).

Database: Any data structure (and/or combinations of multiple data structures) for storing and/or organizing data, including, but not limited to, relational databases (e.g., Oracle databases, PostgreSQL databases, etc.), non-relational databases (e.g., NoSQL databases, etc.), in-memory databases, spreadsheets, as comma separated values (CSV) files, eXtendible markup language (XML) files, TeXT (TXT) files, flat files, spreadsheet files, and/or any other widely used or proprietary format for data storage. Databases are typically stored in one or more data stores. Accordingly, each database referred to herein (e.g., in the description herein and/or the figures of the present application) is to be understood as being stored in one or more data stores.

Data Object or Object: A data container for information representing specific things in the world that have a number of definable properties. For example, a data object can represent an entity such as a person, a place, an organization, a technical object such as a machine or computer system or part(s) thereof, or other noun. A data object can represent an event that happens at a point in time or for a duration. A data object can represent a document or other unstructured data source such as an e-mail message, system message, a news report, or a written paper or article. Each data object may be associated with a unique identifier that uniquely identifies the data object. The object's attributes (e.g. metadata about the object) may be represented in one or more properties.

Object Type: Type of a data object (e.g., Person, Event, or Document). Object types may be defined by an ontology and may be modified or updated to include additional object types. An object definition (e.g., in an ontology) may include how the object is related to other objects, such as being a sub-object type of another object type (e.g. an agent may be a sub-object type of a person object type), and the properties the object type may have.

Properties: Attributes of a data object that represent individual data items. At a minimum, each property of a data object has a property type and a value or values.

Property Type: The type of data a property is, such as a string, an integer, or a double. Property types may include complex property types, such as a series data values associated with timed ticks (e.g. a time series), etc.

Property Value: The value associated with a property, which is of the type indicated in the property type associated with the property. A property may have multiple values.

Link: A connection between two data objects, based on, for example, a relationship, an event, and/or matching properties. Links may be directional, such as one representing a payment from person A to B, or bidirectional.

Link Set: Set of multiple links that are shared between two or more data objects.

### Example Improved Solution Design Environment

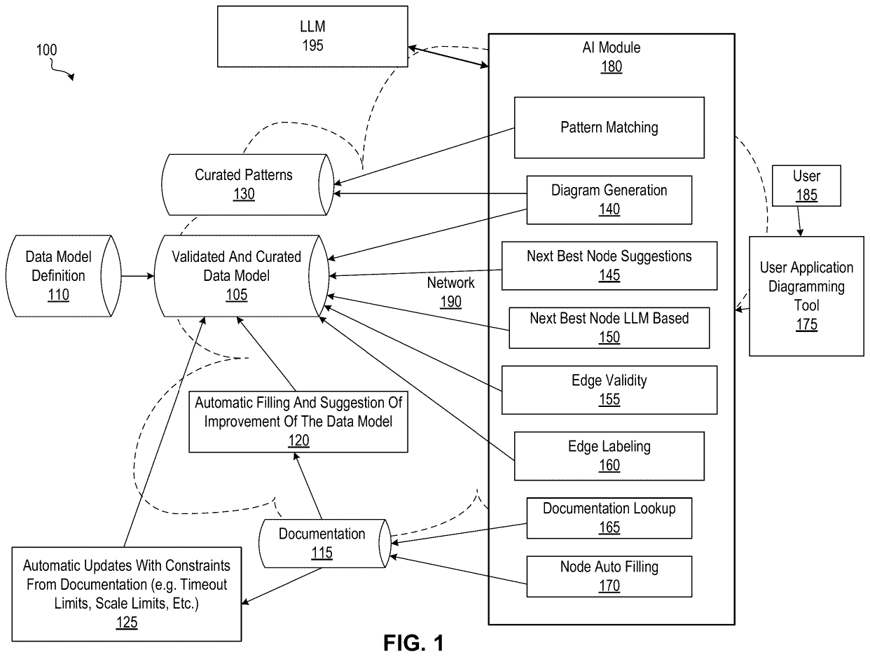

FIG. 1 is a block diagram illustrating one example of an embodiment of a solution design system 100, including AI module 180, that interfaces with several data sources and/or other devices, as well as a user 185 via a user application diagramming tool 175, via a network 190. The network 190 may include, for example, any combination of wired and/or wireless connections, such as the Internet, a local area network, a wide area network and/or a wireless network. In other implementations, a solution design system may include fewer or additional blocks and/or the blocks may be combined or further distributed in different manners.

The AI module 180 is configured to interface with the user 185 via the user application diagramming tool 175. For example, the application diagramming tool 175 may generate user interfaces on a user device, such as in a browser or a standalone application. The user interfaces are configured to aid the user in generating a workflow for accessing, processing, analyzing, combining, etc. data of a data management system. Examples of workflow generation processes are discussed with reference to later figures.

In some embodiments, certain modules of the AI module 180 interact with an LLM 195 to aid in the generation of an optimal operational workflow. Optimal in this context may refer to optimizing, for example reducing or minimizing, the number of processing operations needed to perform the operational workflow; for example, two workflows may perform the same task (achieve the same output), but one may involve less processing resources (for example operations) than the other. The number of processing resources may be estimated, inferred or determined based on, for example, previous use of same or similar components of the workflow and/or in a given relationship to one another. For example, certain of the modules, such as the pattern matching module 135, diagram generation module 140, next best node LLM based module 150, edge labeling module 160, and/or other modules regularly generate prompts to the LLM 195 and receive responses from the LLM 195 that are useful in performance of the specific tasks associated with those modules. In some implementations, other of the modules within the AI modules 180 (e.g., any of the modules 135-170) may interface with the LLM 195 also. Additionally, other artificial intelligence systems may be accessed by any of the AI modules 180. For example, these AI systems may include, but are not limited to, machine learning models, natural language processing engines, and predictive analytics tools. Such AI systems may leverage advanced capabilities such as sentiment analysis, image recognition, and real-time data processing, which can be integrated into the solution design process.

For example, machine learning models can be used to predict user behavior or optimize workflows based on historical data, while natural language processing engines can enhance the system's ability to understand and respond to complex user queries. Predictive analytics tools can provide insights into future trends and potential outcomes, allowing users to make more informed decisions during the solution design process.

The integration of any of these AI systems, including the LLM 195, can be achieved through APIs or other communication protocols, enabling seamless data exchange and collaboration between the AI module 180 and the external systems.

A data model definition 110 represents an initial data model, defining components, relationships, and specifications of entities, such as datasets, processes, or systems. The validated and curated data model 105 comprises a refined version of the initial data definition 110, such as may be enhanced by inputs from various sources. For example, an automatic updates with constraints from documentation 125 may be configured to update the data model with constraints like timeout and scale limits, maintaining compliance with predefined parameters. As another example input to the data model 105, an automatic filling and suggestion of improvement of the data model 120 may be configured to automatically fill gaps and suggest improvements, enhancing the model's completeness and accuracy. Each of the modules 120, 125 may access documentation 115, which may provide information and guidelines to support the development and refinement of the data model. Additionally, the data model 105 may receive inputs from various modules of the AI module 180, which are discussed further below. The AI module 180 may include various modules (135-170 in the example of FIG. 1) that provide various AI-driven functionalities that enhance the data model's utility and user interaction. In the example of FIG. 1, the AI module 180 includes the following example modules.

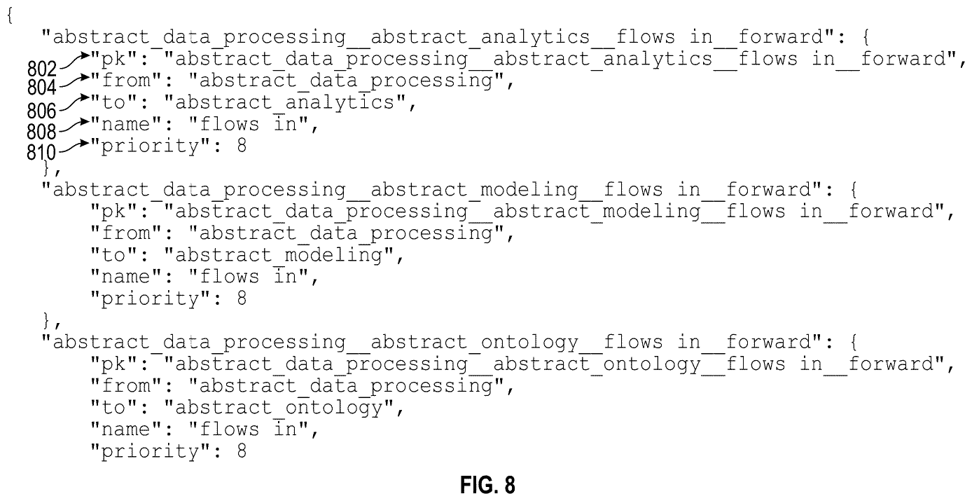

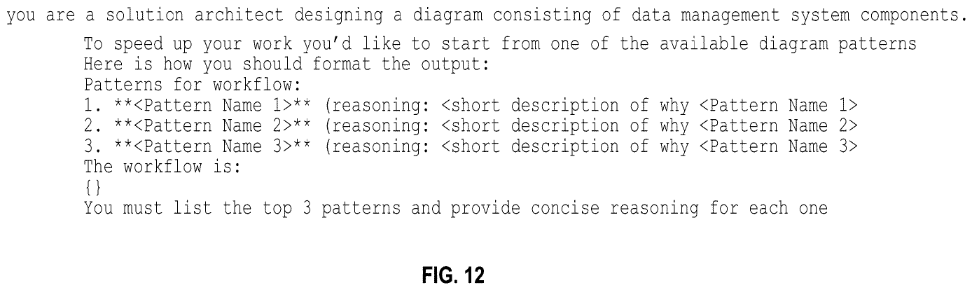

A Pattern Matching module 135 is configured to analyze user prompts to identify relevant patterns by extracting entities (such as site, engineers, or scheduling) and using them for pattern matching. The module 135 may combine both direct pattern searching and entity extraction strategies to provide the most suitable examples for a given use case. For example, a user may provide a task related to implementing a system for managing engineering schedules at a site. The pattern matching module 135 may identify relevant patterns by extracting entities from the user's prompt, such as “site” and “engineers.” Based on these entities, the system may search for examples in its curated patterns library 130 that address similar use cases. For example, the pattern matching module 135 may generate a prompt that is sent to the LLM 195 requesting identification of known patterns of operational workflows that may be relevant to the current user requested workflow. FIG. 12 is an example of a portion of an LLM prompt that may be sent to the LLM 195 in a request for identification of matching patterns. The LLM prompt may further include information regarding the user provided task, a list of components, and a list of relations between components, which are discussed further below. Advantageously, the information provided regarding the components and relationships between components is pre-processed to include only the information necessary for the LLM 195 to identify any relevant patterns (see discussion of FIGS. 8-10 below for further discussion, for example).

For example, the pattern matching module 135 may find an example that involves scheduling workflow management within an engineering site setting. This predefined solution may then be suggested to the user as a starting point or template for designing their custom engineering schedule system using the user application diagramming tool. The suggested example may include components, such as data sets, applications, and external providers specifically tailored to managing engineering schedules effectively within the associated data management system. By leveraging pattern matching via entity extraction, the AI-Assisted Solution Design system can quickly identify relevant examples from its curated patterns library based on user prompts, providing a starting point for users to design their own custom solutions efficiently and accurately. This feature helps to streamline the solution design process for both new and experienced users by offering valuable insights into best practices and common workflows within the Palantir Fabric ecosystem.

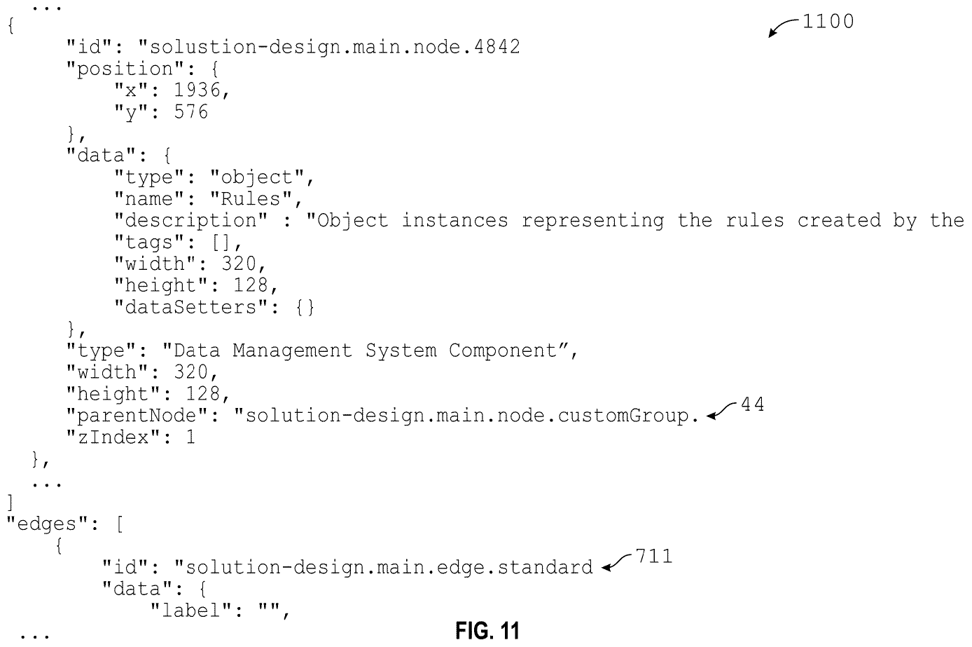

A diagram Generation module 140 is configured to generate diagrams representing a proposed solution using components from one or more of the data management system's data model and external providers. The module 140 may consider valid relationships between components to ensure that generated designs are implementable in the chosen data management system(s). The diagram generation module 140 may also communicate with the LLM 195 to receive details regarding a proposed workflow for presentation to the user. FIG. 11, for example, illustrates an example of a portion of a workflow diagram that may be generated directly from the LLM 195 in response to a prompt from the diagram generation module 140. An example portion of a prompt that may result in workflow diagram code, such as FIG. 11, is discussed further below with reference to FIGS. 8-10.

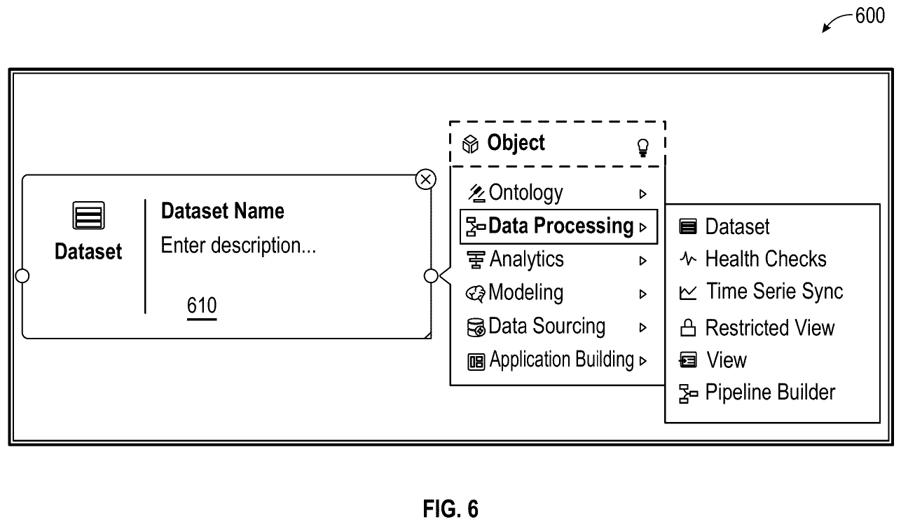

A Next Best Node module 145 is configured to suggest the next relevant node or component based on graph traversal, speeding up the process by offering common and high-priority workflows. The next best node suggestion module may, for example, perform graph traversal in the data model to identify the next relevant node or component that should be considered based on common and high-priority workflows. Additionally, the next best node module 145 may consider validity of connections between nodes, such as based on defined relationships between the components. FIG. 6 is an example user interface 600 illustrating a pop-up menu that provides next best node suggestions for a dataset component 610. By offering these suggestions, users can quickly identify the next steps needed to create an effective solution within the data management system without needing extensive knowledge of its complexities.

A Next Best Node LLM Based module 150 is configured to interact with the LLM 195 (and/or other AI) to enhance node suggestions, providing advanced guidance to the user, such as by identifying next node suggestions, or de-prioritizing next node suggestions generated by the module 145, based on relationships of components that are beyond deterministic relationships between components.

An Edge Validity module 155 is configured to check if connections between components are valid, flagging invalid relationships with visual cues. For example, the module 155 may flag invalid relationships (e.g., attempting to connect incompatible components) with visual cues like yellow highlighting of edges between component nodes, ensuring users do not design solutions that cannot be implemented in the data management system. In some implementations, a user may be provided further information regarding a flagged invalid relationship, such as information regarding why the relationship is considered invalid and suggestions on creating a valid relationship. For example, the user may be provided with information indicating additional and/or different nodes that could be included in the graph to resolve the invalid relationship.

An Edge Labeling module 160 is configured to provide descriptive labels for connections, clarifying relationships. For example, the module 160 may provide explanations for why certain edges or relationships are valid or invalid according to the data model and data management system rules.

A Documentation Lookup module 165 is configured to direct users to relevant documentation for informed decision-making, supporting learning about new components. For example, the module 165 may be aware of entities within its data model and can redirect users to relevant documentation if they seek more information about a particular component or relationship. This feature supports users in learning about new components and functionalities as they work with the solution design tool. In some embodiments, the documentation lookup module 165 directs the user to an AI assistant that may further guide the user in obtaining further information regarding the relevant components and/or graph.

A Node Auto Filling module 170 is configured to propose concrete implementations for certain nodes, such as abstract or general nodes. For example, when designing a solution, users might be unfamiliar with specific components or their functionalities. The module 170 may propose implementations for abstract nodes (e.g., data sourcing) based on the connected systems in the graph. For example, when a user creates and connects a node representing data sourcing to a recognized system within the data management system (e.g., a particular cloud data source), the Node Auto Filling module 170 may propose how to connect to that system, automatically filling in necessary steps and components for a successful integration. The module 170 might use a list of known systems and connection methods to suggest suitable options when connecting abstract nodes to specific systems within the data management system.

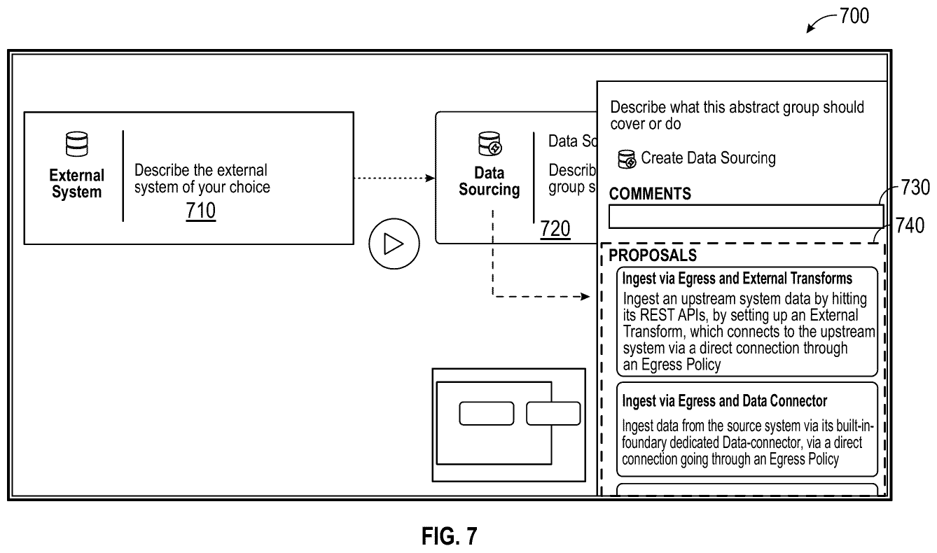

FIG. 7 is a user interface 700 illustrating an example interaction between a user and the Node Auto Filling module 170. In this example, the user selects to connect an external system 710 with a data sourcing component 720. The module 170 may receive additional information on the connection from the user in a comment box 730, and provide one or more proposals 740 on how the connection might be accomplished. The user can select one of the proposed solutions or ask for additional suggestions by providing more comments, allowing the details of the connection to be finalized based on their selection. This capability simplifies the process for users, ensuring they can create accurate and implementable solutions without extensive knowledge of each individual component's intricacies.

A Curated Patterns library 130 stores established patterns of workflows. As discussed further below, these patterns may be accessed by the user 185 for use as a starting point for a workflow. The curated patterns may include predefined examples that show how to resolve specific use cases effectively using the data management system's components and relationships. These patterns may be created by developers and represent best practices or common workflows for addressing various business problems within a data management system. The patterns may be associated with respective known or estimated numbers of processing operations required to perform the workflows or parts thereof.

In some embodiments, the curated patterns library 130 serves as a reference guide, helping users to jump-start their solution design process and understand how different parts of the data management system can work together coherently to achieve desirable outcomes. By leveraging these examples, users can save time and effort by having a clear starting point for designing their custom solutions, ultimately leading to faster problem resolution. Additionally, the curated patterns library 130 offers valuable insights into the capabilities and limitations of the particular data management system where the workflow is to be implemented.

A User Application Diagramming Tool 175 may be configured to provide user interfaces through which the user 185 interacts with the system, utilizing the functionalities of the AI module 180 to create and refine workflows. The User Application Diagramming Tool 175 provides a user-friendly interface where users can create diagrams by connecting different components based on valid relationships, ensuring the generated designs are feasible within the chosen data management system(s).

The Tool 175 leverages the data model of the data management system to propose relevant components and connections to users as they build their solutions, such as through the various modules of the AI module 180. In some implementations, diagrams generated by the tool 175 provide users a high-level overview of their solutions, making it easier for them to understand the flow of data and processes within their designs. This visual representation can be valuable in communicating the proposed solution to stakeholders or other team members, ensuring everyone is on the same page regarding the intended functionality and implementation details.

The user 185 represents the end-user who engages with the user application diagramming tool 175 to interact with the data model and AI functionalities. A user, or “user 185”, as used herein, may refer to a human user and/or the computing system (e.g., the desktop, laptop, or mobile device used to communicate with the tool 175) of the human user.

### Example Data Management System

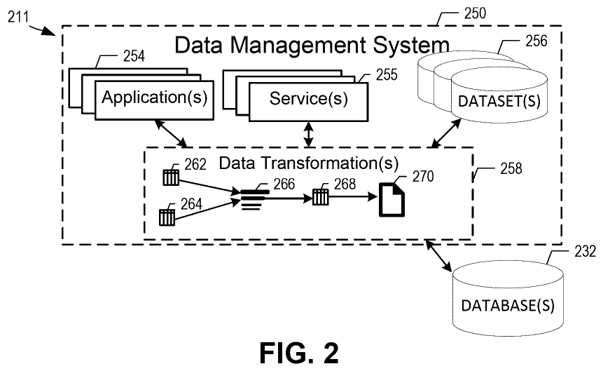

FIG. 2 illustrates an example data management system 250 according to some embodiments of the present disclosure. In particular, the solutions designed using the system of FIG. 1 may be implemented using the data management system 250. In the embodiments of FIG. 2, a computing environment 211 can be similar to, overlap with, and/or be used in conjunction with the computing environment of FIG. 1.

The example data management system 250 includes one or more applications 254, one or more services 255, one or more initial datasets 256, and a data transformation process 258 (also referred to herein as a build process). In some embodiments, the data management system 250 may also include ingestion interfaces and connectors for structured and unstructured data sources, enabling automated or manual ingestion of data from databases, APIs, file systems, or streaming data platforms. The example data management system 250 can include a data pipeline system. The data management system 250 can transform data and record the data transformations. The one or more applications 254 can include applications that enable users to view datasets, interact with datasets, filter data sets, and/or configure dataset transformation processes or builds. The one or more services 255 can include services that can trigger the data transformation builds and API services for receiving and transmitting data. The one or more initial datasets 256 can be automatically retrieved from external sources and/or can be manually imported by a user. The one or more initial datasets 256 can be in many different formats such as a tabular data format (SQL, delimited, or a spreadsheet data format), a data log format (such as network logs), or time series data (such as sensor data). The system may also maintain metadata about the data sources (e.g., schemas, update frequencies, and ownership).

The data management system 250, via the one or more services 255, can apply the data transformation process 258. An example data transformation process 258 is shown. The data management system 250 can receive one or more initial datasets 262, 264. The data management system 250 can apply a transformation to the dataset(s). For example, the data management system 250 can apply a first transformation 266 to the initial datasets 262, 264, which can include joining the initial datasets 262, 264 (such as or similar to a SQL JOIN), and/or a filtering of the initial datasets 262, 264. The output of the first transformation 266 can include a modified dataset 268. A second transformation of the modified dataset 268 can result in an output dataset 270, such as a report or a joined table in a tabular data format that can be stored in the database 232. Each of the steps in the example data transformation process 258 can be recorded by the data management system 250 and made available as a resource to the AI solution design system of FIG. 1. For example, a resource can include a dataset and/or a dataset item, a transformation, or any other step in a data transformation process. As mentioned above, the data transformation process or build 258 can be triggered by the data management system 250, where example triggers can include nightly build processes, detected events, or manual triggers by a user. Additional aspects of data transformations and the data management system 250 are described in further detail below. In some implementations, real-time or near-real-time data processing may be supported, enabling continuous updates to transformations as new data arrives.

The techniques for recording and transforming data in the data management system 250 may include maintaining an immutable history of data recording and transformation actions such as uploading a new dataset version to the data management system 250 and transforming one dataset version to another dataset version. The immutable history is referred to herein as “the catalog.” The catalog may be stored in a database. Preferably, reads and writes from and to the catalog are performed in the context of ACID-compliant transactions supported by a database management system. For example, the catalog may be stored in a relational database managed by a relational database management system that supports atomic, consistent, isolated, and durable (ACID) transactions.

The catalog can include versioned immutable “datasets.” More specifically, a dataset may encompass an ordered set of conceptual dataset items. The dataset items may be ordered according to their version identifiers recorded in the catalog. Thus, a dataset item may correspond to a particular version of the dataset. A dataset item may represent a snapshot of the dataset at a particular version of the dataset. As a simple example, a version identifier of ‘1’ may be recorded in the catalog for an initial dataset item of a dataset. If data is later added to the dataset, a version identifier of ‘2’ may be recorded in the catalog for a second dataset item that conceptually includes the data of the initial dataset item and the added data. In this example, dataset item ‘2’ may represent the current dataset version and is ordered after dataset item ‘1’.

As well as being versioned, a dataset may be immutable. That is, when a new version of the dataset corresponding to a new dataset item is created for the dataset in the system, pre-existing dataset items of the dataset are not overwritten by the new dataset item. In this way, pre-existing dataset items (i.e., pre-existing versions of the dataset) are preserved when a new dataset item is added to the dataset (i.e., when a new version of the dataset is created). Note that supporting immutable datasets is not inconsistent with pruning or deleting dataset items corresponding to old dataset versions. For example, old dataset items may be deleted from the system to conserve data storage space.

A version of dataset may correspond to a successfully committed transaction against the dataset. In these embodiments, a sequence of successfully committed transactions against the dataset corresponds to a sequence of dataset versions of the dataset (i.e., a sequence of dataset items of the dataset).

A transaction against a dataset may add data to the dataset, edit existing data in the dataset, remove existing data from the dataset, or a combination of adding, editing, or removing data. A transaction against a dataset may create a new version of the dataset (i.e., a new dataset item of the dataset) without deleting, removing, or modifying pre-existing dataset items (i.e., without deleting, removing, or modifying pre-existing dataset versions). A successfully committed transaction may correspond to a set of one or more files that contain the data of the dataset item created by the successful transaction. The set of files may be stored in a file system.

In the catalog, a dataset item of a dataset may be identified by the name or identifier of the dataset and the dataset version corresponding to the dataset item. In a preferred embodiment, the dataset version corresponds to an identifier assigned to the transaction that created the dataset version. The dataset item may be associated in the catalog with the set of files that contain the data of the dataset item. In a preferred embodiment, the catalog treats the set of files as opaque. That is, the catalog itself may store paths or other identifiers of the set of files but may not otherwise open, read, or write to the files.

In sum, the catalog may store information about datasets. The information may include information identifying different versions (i.e., different dataset items) of the datasets. In association with information identifying a particular version (i.e., a particular dataset item) of a dataset, there may be information identifying one or more files that contain the data of the particular dataset version (i.e., the particular dataset item).

The catalog may store information representing a non-linear history of a dataset. Specifically, the history of a dataset may have different dataset branches. Branching may be used to allow one set of changes to a dataset to be made independent and concurrently of another set of changes to the dataset. The catalog may store branch names in association with dataset version identifiers for identifying dataset items that belong to a particular dataset branch.

The catalog may provide dataset provenance at the transaction level of granularity. As an example, suppose a transformation is executed in the data management system 250 multiple times that reads data from dataset A, reads data from dataset B, transforms the data from dataset A and the data from dataset B in some way to produce dataset C. As mentioned, this transformation may be performed multiple times. Each transformation may be performed in the context of a transaction. For example, the transformation may be performed daily after datasets A and B are updated daily in the context of transactions. The result being multiple versions of dataset A, multiple versions of dataset B, and multiple versions of dataset C as a result of multiple executions of the transformation. The catalog may contain sufficient information to trace the provenance of any version of dataset C to the versions of datasets A and B from which the version of dataset C is derived. In addition, the catalog may contain sufficient information to trace the provenance of those versions of datasets A and B to the earlier versions of datasets A and B from which those versions of datasets A and B were derived.

The provenance tracking ability is the result of recording in the catalog for a transaction that creates a new dataset version, the transaction or transactions that the given transaction depends on (e.g., is derived from). The information recorded in the catalog may include an identifier of each dependent transaction and a branch name of the dataset that the dependent transaction was committed against.

According to some embodiments, provenance tracking extends beyond transaction level granularity to column level granularity. For example, suppose a dataset version A is structured as a table of two columns and a dataset version B is structured as a table of five columns. Further assume, column three of dataset version B is computed from column one of dataset version A. In this case, the catalog may store information reflecting the dependency of column three of dataset version B on column one of dataset version A.

The catalog may also support the notion of permission transitivity. For example, suppose the catalog records information for two transactions executed against a dataset referred to in this example as “Transaction 1” and “Transaction 2.” Further suppose a third transaction is performed against the dataset which is referred to in this example as “Transaction 3.” Transaction 3 may use data created by Transaction 1 and data created by Transaction 2 to create the dataset item of Transaction 3. After Transaction 3 is executed, it may be decided according to organizational policy that a particular user should not be allowed to access the data created by Transaction 2. In this case, as a result of the provenance tracking ability, and in particular because the catalog records the dependency of Transaction 3 on Transaction 2, if permission to access the data of Transaction 2 is revoked from the particular user, permission to access the data of Transaction 3 may be transitively revoked from the particular user.

The transitive effect of permission revocation (or permission grant) can apply to an arbitrary number of levels in the provenance tracking. For example, returning to the above example, permission may be transitively revoked for any transaction that depends directly or indirectly on Transaction 3.

According to some embodiments, where provenance tracking in the catalog has column level granularity, permission transitivity may apply at the more fine-grained column level. In this case, permission may be revoked (or granted) on a particular column of a dataset and based on the column-level provenance tracking in the catalog, permission may be transitively revoked on all direct or indirect descendent columns of that column. Additionally, role-based access controls may allow administrators to set varying permission tiers (e.g., read, write, admin) on dataset columns or entire datasets, ensuring compliance with organizational or regulatory policies.

A build service can manage transformations which are executed in the system to transform data. The build service may leverage a directed acyclic graph data (DAG) structure to ensure that transformations are executed in proper dependency order. The graph can include a node representing an output dataset to be computed based on one or more input datasets each represented by a node in the graph with a directed edge between node(s) representing the input dataset(s) and the node representing the output dataset. The build service traverses the DAG in dataset dependency order so that the most upstream dependent datasets are computed first. The build service traverses the DAG from the most upstream dependent datasets toward the node representing the output dataset rebuilding datasets as necessary so that they are up-to-date. Finally, the target output dataset is built once all of the dependent datasets are up-to-date. Some implementations may support dynamic scaling of computation resources (e.g., through container orchestration) to optimize build times when dealing with large or complex DAGs.

The data management system 250 can support branching for both data and code. Build branches allow the same transformation code to be executed on multiple branches. For example, transformation code on the master branch can be executed to produce a dataset on the master branch or on another branch (e.g., the develop branch). Build branches also allow transformation code on a development branch to be executed to produce a dataset that is available only on the development branch. Build branches provide isolation of re-computation of graph data across different users and across different execution schedules of a data pipeline. To support branching, the catalog may store information representing a graph of dependencies as opposed to a linear dependency sequence. This branching mechanism can be leveraged in collaborative environments, where multiple teams iteratively develop and test transformations before merging them into production.

The data management system 250 may enable other data transformation systems to perform transformations. For example, suppose the system stores two “raw” datasets R1 and R2 that are both updated daily (e.g., with daily web log data for two web services). Each update creates a new version of the dataset and corresponds to a different transaction. The datasets are deemed raw in the sense that transformation code may not be executed by the data management system 250 to produce the datasets. Further suppose there is a transformation A that computes a join between datasets R1 and R2. The join may be performed in a data transformation system such as a SQL database system, for example. More generally, the techniques described herein are agnostic to the particular data transformation engine that is used. The data to be transformed and the transformation code to transform the data can be provided to the engine based on information stored in the catalog including where to store the output data. In some cases, data scientists and developers may also leverage external libraries or machine learning frameworks to run advanced analytics tasks—such as statistical analysis, clustering, or predictive modeling—while preserving data lineage within the catalog.

According to some embodiments, the build service supports a push build. In a push build, rebuilds of all datasets that depend on an upstream dataset or an upstream transformation that has been updated are automatically determined based on information in the catalog and rebuilt. In this case, the build service may accept a target dataset or a target transformation as an input parameter to a push build command. The build service then determines all downstream datasets that need to be rebuilt, if any.

As an example, if the build service receives a push build command with dataset R1 as the target, then the build service would determine all downstream datasets that are not up-to-date with respect to dataset R1 and rebuild them. For example, if dataset D1 is out-of-date with respect to dataset R1, then dataset D1 is rebuilt based on the current versions of datasets R1 and R2 and the current version of transformation A. If dataset D1 is rebuilt because it is out-of-date, then dataset D2 will be rebuilt based on the up-to-date version of dataset D1 and the current version of transformation B and so on until all downstream datasets of the target dataset are rebuilt. The build service may perform similar rebuilding if the target of the push build command is a transformation.

The build service may also support triggers. In this case, a push build may be considered a special case of a trigger. A trigger, generally, is a rebuild action that is performed by the build service that is triggered by the creation of a new version of a dataset or a new version of a transformation in the system. Additionally, the system may provide scheduling and orchestration capabilities so that organizations can configure complex recurring builds that execute transformations at specified intervals or in response to events.

A schema metadata service can store schema information about files that correspond to transactions reflected in the catalog. An identifier of a given file identified in the catalog may be passed to the schema metadata service and the schema metadata service may return schema information for the file. The schema information may encompass data schema related information such as whether the data in the file is structured as a table, the names of the columns of the table, the data types of the columns, user descriptions of the columns, etc.

The schema information can be accessible via the schema metadata service and may be versioned separately from the data itself in the catalog. This allows the schemas to be updated separately from datasets and those updates to be tracked separately. For example, suppose a comma separated file is uploaded to the system as a particular dataset version. The catalog may store in association with the particular dataset version identifiers of one or more files in which the CSV data is stored. The catalog may also store in association with each of those one or more file identifiers, schema information describing the format and type of data stored in the corresponding file. The schema information for a file may be retrievable via the schema metadata service given an identifier of the file as input. Note that this versioning scheme in the catalog allows new schema information for a file to be associated with the file and accessible via the schema metadata service. For example, suppose after storing initial schema information for a file in which the CSV data is stored, updated schema information is stored that reflects a new or better understanding of the CSV data stored in the file. The updated schema information may be retrieved from the schema metadata service for the file without having to create a new version of the CSV data or the file in which the CSV data is stored.

When a transformation is executed, the build service may encapsulate the complexities of the separate versioning of datasets and schema information. For example, suppose transformation A described above in a previous example that accepts the dataset R1 and dataset R2 as input is the target of a build command issued to the build service. In response to this build command, the build service may determine from the catalog the file or files in which the data of the current versions of datasets R1 and R2 is stored. The build service may then access the schema metadata service to obtain the current versions of the schema information for the file or files. The build service may then provide all of identifiers or paths to the file or files and the obtained schema information to the data transformation engine to execute the transformation A. The underlying data transformation engine interprets the schema information and applies it to the data in the file or files when executing the transformation A. In addition, the data management system 250 may expose APIs or SDKs that allow external tools and systems to request updates or retrieve data for further processing, integrating seamlessly into broader enterprise ecosystems.

### Example User Interfaces

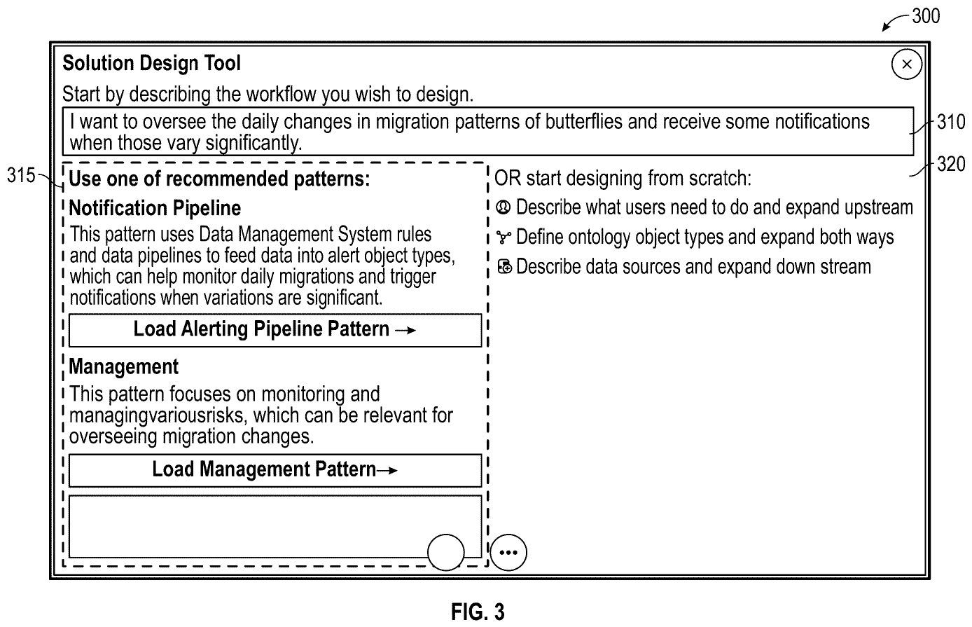

FIG. 3 is an example user interface 300 that may serve as a starting screen for the solution design tool. As discussed further herein, the solution design tool is advantageously in figure to allow a user to provide a generally problem and/or solution, without technical knowledge of backend database accesses, operations, etc. that might be available in a data management system and guide the user via continued and/or guided human-machine interaction process through generation and customization of a workflow for achieving the provided problem and/or solution. Many data management systems may include tens, hundreds, or even thousands of components (or tools) that enable the accessing, analyzing, and processing of data from multiple sources to produce actionable insights. These components may include tools for graph analysis (e.g., visually exploring relationships in connected databases), data exploration (e.g., creating interactive charts, tables, and filters for large datasets), data modeling (e.g., writing custom code and integrating external libraries), an interactive dashboard tool (e.g., analyzing tabular data and building dashboards without coding), transactional data collection (e.g., storing files and related metadata in a transactional manner), data health monitoring (e.g., tracking the state of data and sending alerts when conditions change), data integration (e.g., importing or exporting data to external systems), a reporting/document tool (e.g., generating live or point-in-time snapshots of data in a report-like format), alerts and notifications (e.g., sending messages within the data management system or through email), entity definition (e.g., representing real-world objects at various granularities), relationship definition (e.g., establishing connections among entities), and an access control group (e.g., defining permissions for user groups). However, many users, particularly non-technical users, of the data management system may have limited or no knowledge of how these various components operate alone or in cooperation with other components. Thus, the solution design system discussed herein provides those non-technical users (as well as any other users) options for quickly and effectively making use of the various available components in generating a workflow that serves the goal.

In the example of FIG. 3, the user interface 300 may be presented to the user 185 (FIG. 1) when the user initiates the process of generating a workflow to access, analyze, convert, update, display, etc. information from one or more data management systems. In this example, the user interface 300 includes an input box 310 where the user can provide a textual description of a problem and/or solution that they are addressing with the requested workflow. Input may be provided via any available input device such as a keyboard, dictation (e.g., voice to text), virtual headset, etc. In this example, the user interface 300 provides two general paths for generation of a workflow, namely, a pattern based area 315 and a fully customized area 320. In this example, the pattern based area 315 is populated with patterns that may be relevant to the user's task, such as may be determined by the AI module 180 based on analysis of the user input provided in input box 310. Thus, the user may select one of the provided, recommended, patterns in pattern based area 315 or the user may select the fully customized area 320 to start from scratch in generating a workflow.

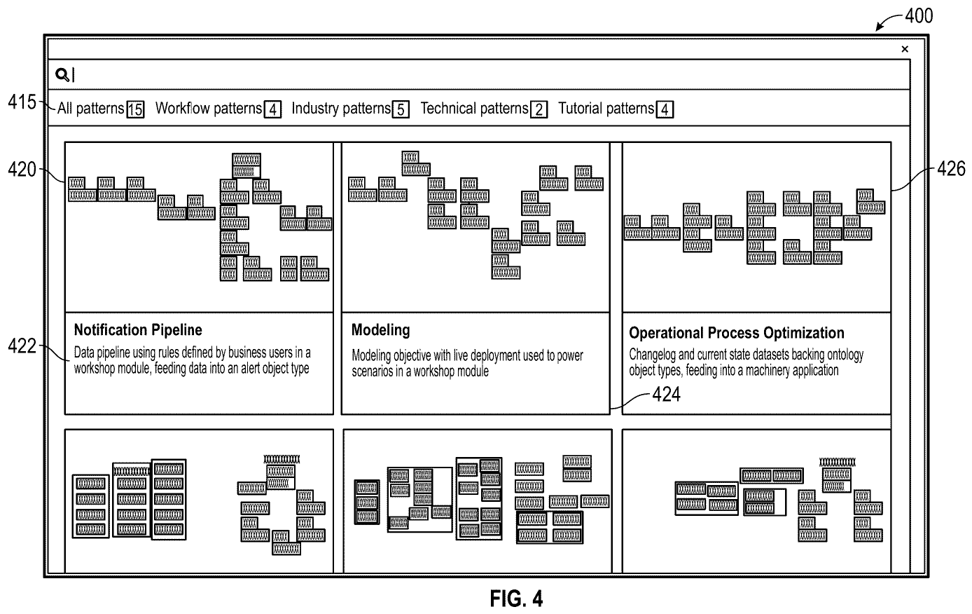

FIG. 4 is an example user interface 400 that provides additional patterns available to the user as a starting point for a customized workflow. As shown, the user may select categories of workflows of interest using the category selectors 415 to limit the patterns displayed. In this example, all patterns are shown, beginning with a notification pipeline 422, a modeling pipeline 424 and a operational process optimization pipeline 426. The user may select any of these patterns to have the pattern loaded into a diagram editing user interface of the application diagramming tool 175 for further modification and/or customization.

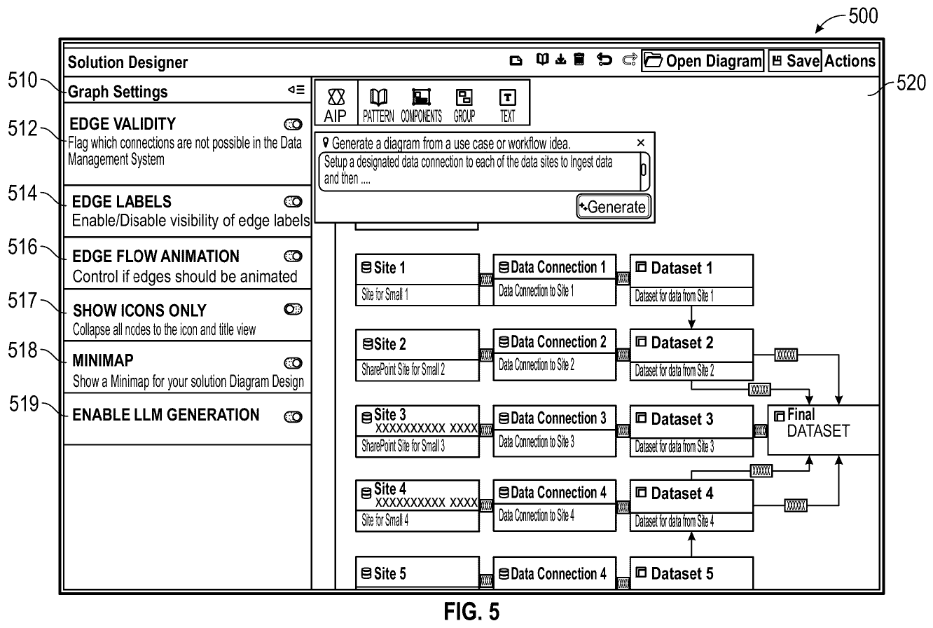

FIG. 5 illustrates a user interface 500 representing a workflow editing user interface of the application diagramming tool 175. In this example, a graph settings pane 510 includes user adjustable settings that are to be applied in generating the workflow. In this example, the options include an edge validity option 512, an edge label option 514, an edge flow animation option 516, a show icons option 517, a mini map option 518, and an enable LLM generation option 519. Certain of these settings, when activated, invoke one or more of the AI modules 180. For example, the edge validity option 512 may be activated (turned on) to activate the automatic validity of edges. With this option activated, the module 155 will automatically identify and flag any connections that are not possible, for example ones that will break the workflow, if implemented as executable code, such as by showing them in a different color or format in the workflow graph. Another example is the edge labels option 514 which, when activated, may enable the automatic labeling of edges module 160 to automatically generate descriptions of edges and provide the descriptions on the workflow graph. The enable LLM generation option 519 may be used to activate LLM-based functionalities. These options are only examples of settings that may be provided to a user.

In the example of FIG. 5, a graphing pane 520 displays a current workflow diagram (or “graph”) and allows the user to interact with the diagram, such as by adding, removing, and/or updating nodes of the graph. In this example, the graph represents an example of what may be created automatically by the solution design system 100, e.g., by the diagram generation module 140, in response to a natural language user input, such as via the input box 310 of FIG. 3. For example, in some implementations the diagram generation module 140 may access the curated patterns 130, responsive to the user input in the input box 310 of FIG. 3, to identify portions of curated patterns that may address the user request. The diagram generation module 140 may combine portions of any curated patterns and/or add additional nodes to the initially provided graph (e.g., in graphing pane 520 of FIG. 5) as a starting point for generation of a suitable workflow graph by the user. If, however, the diagram generation module 140 does not identify any patterns in the curated patterns 130 of interest, nodes and connections of the initial graph may be generated automatically by the diagram generation module 140.

### Granularity of Data Model

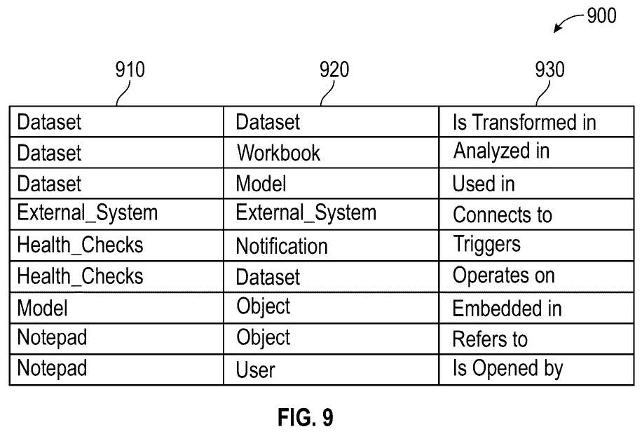

To ensure efficient interaction between the AI modules and the data model, only the properties of the available components that are necessary for accurate processing are provided to the LLM. The original data model might include numerous properties for each component, many of which may not be necessary for the AI module 180 to guide the user through workflow graph development. For example, a data model may include properties for components such as primary key (pk), title, priority, brief description, full description, node title placeholder, node description, type, tags, state, color, app icon, resource icon, icon, documentation links, example link, group, supergroup, validated, notes, and others. However, the AI modules only require a subset of these properties to navigate through the complexities of the data management system effectively. Additionally, relationships between components, such as which components are connectable to other components, may not be easily determinable from the individual component properties, and the properties for the components may exceed the LLM context window (e.g., may be too large to pass to the LLM). Thus, in some embodiments, the system generates the validated and curated data model 105 that includes only the properties of the components necessary for workflow diagram generation. FIG. 9 is an example table of information indicating relationships between a few example components. In this example, a first component 910 may have a specified relationship 930 with a second component 920. FIG. 8 is an example of a portion of a relational data model that may be generated based on properties of available components and provided to an LLM as part of a graph-building prompt. In the example of FIG. 8, the relational data model includes limited information, such as a pk 802 indicating a primary key of the component, a “from” property 804 indicating one or more components from which data may be received, a “to” property 806 indicating one or more components to which data may be transmitted from this particular component, a “name” property 808 indicating how the information is transmitted between components, and a “priority” property 810 indicating a priority of connections to or from this component.

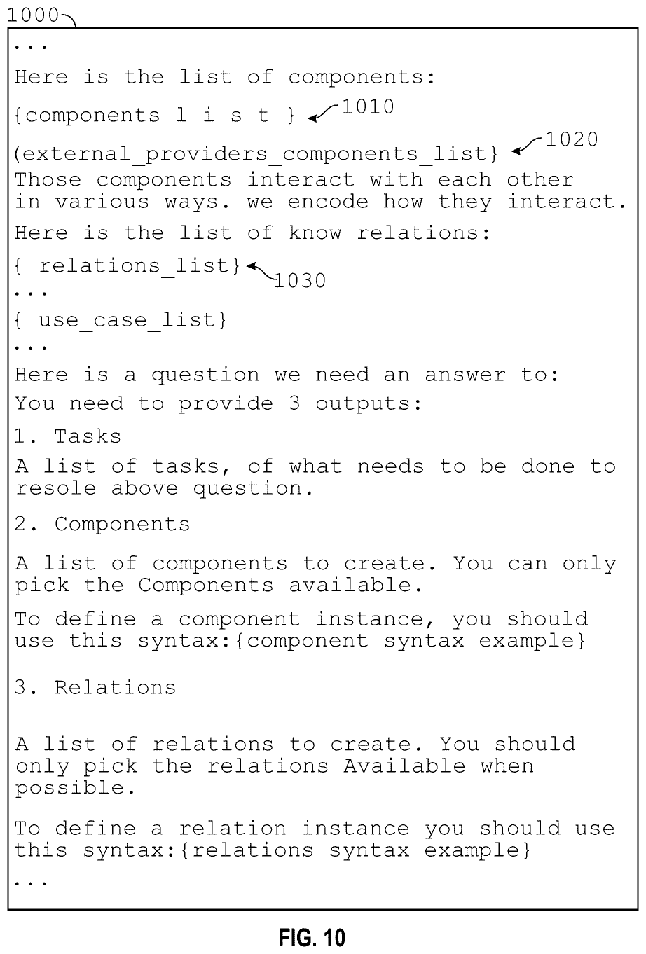

In some implementations, the priorities are used to resolve and/or prioritize connections between components when multiple connections are possible. For example, if a particular component is properly connectable to multiple other components (e.g., the “to” and “from” properties are compatible between the components), a highest priority component may be automatically selected and/or suggested as the most likely connection to the user. This relational data model may be included in a prompt to the LLM requesting the generation of a workflow graph. FIG. 10 is an example of a portion of an LLM prompt 1000 that may be generated as an initial request for information on a workflow graph. In the example of FIG. 10, the prompt includes a component list 1010 and an external providers component list 1020. Advantageously, the component lists allow workflow graphs to be generated that interact with not only a single system (e.g., a data management system of an organization) but also any other system that is accessible (e.g., a third-party system, such as an external AWS, S3, or GCP system). The example prompt 1000 also includes a relations list 1030 that indicates acceptable relationships between components. For example, the relations list may include information in the format illustrated in FIGS. 8 and/or 9. The prompt continues by outlining the information expected from the LLM in return, including a list of tasks, components, and relations, as shown in the example of FIG. 10. FIG. 11 is one example of a response from an LLM that includes information regarding draft components selected by the LLM in response to the prompt 1000.

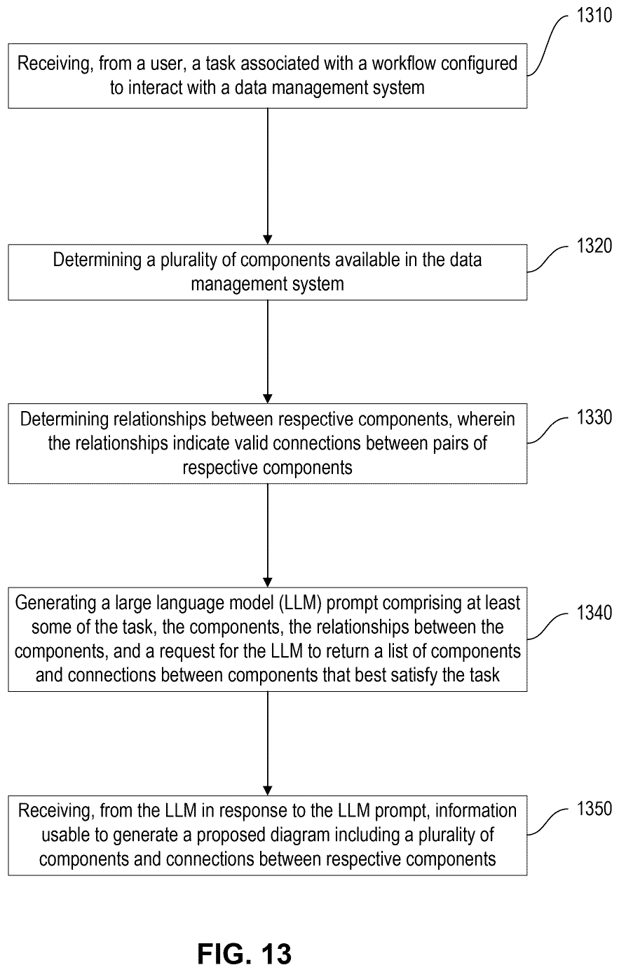

FIG. 13 is a flowchart illustrating an example method for AI-assisted solution design, performed by a computing system, such as the system 100 in FIG. 1. Depending on the embodiment, the method may include fewer or additional blocks and/or the blocks may be performed in an order different than is illustrated.

Beginning at block 1310, the system receives, from a user, a task associated with a workflow configured to interact with a data management system. Natural language processing may be performed to interpret the user input, enhancing the system's ability to understand complex user queries and translate them into actionable tasks.

Next, at block 1320, the system determining a plurality of components available in the data management system, such as by querying a dynamic database of components, allowing for real-time updates and scalability as new components are added to the system. System efficiency may be improved by identifying relevant components, ensuring that the workflow is built using the most appropriate resources.

Moving to block 1330, relationships between respective components are determined, wherein the relationships indicate valid connections between pairs of respective components. For example, graph traversal algorithms may be utilized to efficiently map out potential connections and dependencies. This provides technical improvements by ensuring that only valid and logical connections are established, reducing errors in workflow execution.

At block 1340, a large language model (LLM) prompt is generated to include at least some of the task, the components, the relationships between the components, and a request for the LLM to return a list of components and connections between components that best satisfy the task. The prompt generation may incorporate context-aware filtering to ensure that only relevant information is included, optimizing the LLM's processing efficiency. This also leverages advanced AI capabilities to optimize workflow design by utilizing LLMs to suggest the most effective component configurations.

At block 1350, a response from the LLM is received, including information usable to generate a proposed diagram including a plurality of components and connections between respective components. This enhances the design process by providing users with a visual representation of the proposed workflow, facilitating easier understanding and further refinement. The system may employ visualization tools to dynamically render the diagram, allowing for interactive user feedback and iterative design improvements.

### Example Implementations

Examples of the implementations of the present disclosure can be described in view of the following example clauses. The features recited in the below example implementations can be combined with additional features disclosed herein. Furthermore, additional inventive combinations of features are disclosed herein, which are not specifically recited in the below example implementations, and which do not include the same features as the specific implementations below. For sake of brevity, the below example implementations do not identify every inventive aspect of this disclosure. The below example implementations are not intended to identify key features or essential features of any subject matter described herein. Any of the example clauses below, or any features of the example clauses, can be combined with any one or more other example clauses, or features of the example clauses or other features of the present disclosure.

Clause 1. A computerized method, performed by a computing system having one or more hardware computer processors and one or more non-transitory computer readable storage device storing software instructions executable by the computing system to perform the computerized method comprising: receiving, from a user, a task associated with a workflow configured to interact with a data management system; determining a plurality of components available in the data management system; determining relationships between respective components, wherein the relationships indicate valid connections between pairs of respective components; generating a large language model (LLM) prompt comprising at least some of the task, the components, the relationships between the components, and a request for the LLM to return a list of components and connections between components that best satisfy the task; and receiving, from the LLM in response to the LLM prompt, information usable to generate a proposed diagram including a plurality of components and connections between respective components. In some examples, the plurality of components and valid connections are capable of being compiled into executable instructions for performing the task, and the compiling may be initiated by the user.

Clause 2. The method of clause 1, wherein the prompt further includes, for each of the included components, a type, instance title, and description.

Clause 3. The method of clause 1, further comprising: generating a second LLM prompt including at least some of the task, a list of diagram templates representing common workflows, and a request for the LLM to identify any of the diagram templates that are relevant to the task; and receiving, from the LLM in response to the second LLM prompt, an indication of at least a first diagram template.

Clause 4. The method of clause 3, further comprising: comparing the first diagram template with the proposed diagram to determine which is optimal for addressing the task. This may involve determining (or estimating) first processing resources (e.g., a number of operations) for executing executable code associated with the proposed diagram, and second processing resources (e.g., another number of operations) for executing executable code associated with the first diagram template, for example based on earlier uses of the first diagram template. The comparing of the first diagram template with the proposed diagram to determine which is optimal for addressing the task may comprise comparing the first and second processing resources and indicating that which uses least processing resources. That which is least may be indicated to a user interface, for example to inform the user of the most optimal diagram to perform the same task, and for enabling the user to initiate via the user interface compiling of the most optimal workflow to create the executable code.

Clause 5. The method of clause 1, wherein the components and relationships are pre-processed and stored in files that are injected into the LLM prompt.

Clause 6. The method of clause 1, further comprising: accessing a list of component properties for each of the plurality of components, wherein the component properties include at least a title, brief description, type, and group component properties; extracting, from the component properties of each of the components, key component properties including a primary key, title, and brief description; storing the key component properties; determining, based at least on the component properties of the plurality of components, valid relationships between respective pairs of components, wherein valid relationships indicate pairs of components that can receive or send data to the other of the pair of components; and storing the valid relationships.

Clause 7. The method of clause 1, wherein the component properties include a priority for each component.

Clause 8. The method of clause 1, further comprising: receiving, from the LLM, indications of a plurality of components, including a component, component description, and an edge from the component to another component.

Clause 9. The method of clause 1, wherein each relationship indicates a primary key, from, name, and to properties.

Clause 10. The method of clause 1, wherein each of the components is configured to perform a specific task or operation.

Clause 11. The method of clause 1, wherein each of the components is represented as a node on a workflow diagram.

Clause 12. The method of clause 1, further comprising: executing a pattern matching module to analyze the user task and identify relevant patterns by extracting entities.

Clause 13. The method of clause 1, further comprising: executing a diagram generation module to create a visual representation of the proposed solution, wherein the generated diagram includes valid connections between components as determined by the relationships.

Clause 14. The method of clause 1, further comprising: executing a next best node suggestion module to provide recommendations for subsequent components to be included in the workflow, based on common and high-priority workflows identified in the data model.

Clause 15. The method of clause 1, further comprising: executing a next best node LLM based module to enhance node suggestions by interacting with the LLM, providing guidance on component selection beyond deterministic relationships.

Clause 16. The method of clause 1, further comprising: executing an edge validity module to verify validity of connections between components in the proposed diagram and flagging any invalid relationships with visual cues.

Clause 17. The method of clause 1, further comprising: executing an edge labeling module to generate descriptive labels for connections between components.

Clause 18. The method of clause 1, further comprising: executing a documentation lookup module to direct users to relevant documentation for components and relationships.

Clause 19. The method of clause 1, further comprising: executing a node auto filling module to propose implementations details for abstract nodes in the proposed diagram.

Clause 20. A computerized method, performed by a computing system having one or more hardware computer processors and one or more non-transitory computer readable storage device storing software instructions executable by the computing system to perform the computerized method comprising: receiving, from a user, a task associated with a workflow configured to interact with a data management system; generating a large language model (LLM) prompt comprising at least some of the task and a request for the LLM to identify an existing pattern that best satisfies the task; receiving, from the LLM in response to the LLM prompt, an indication of an existing pattern that includes a plurality of components and connections between respective components; and providing the identified existing pattern to the user as a proposed solution for the task.

### Additional Implementation Details and Embodiments

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Java, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

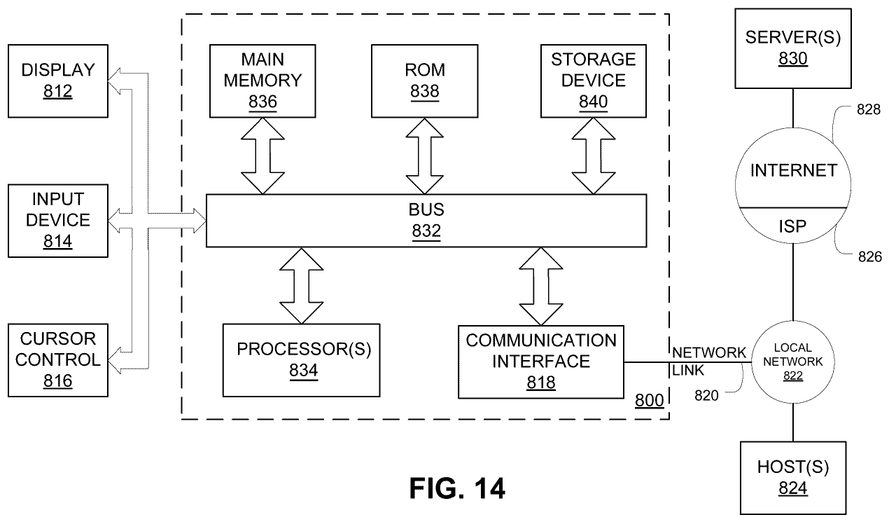

For example, FIG. 14 is a block diagram that illustrates a computer system 800 upon which various embodiments may be implemented. Computer system 800 includes a bus 832 or other communication mechanism for communicating information, and a hardware processor, or multiple processors, 834 coupled with bus 832 for processing information. Hardware processor(s) 834 may be, for example, one or more general purpose microprocessors.

Computer system 800 also includes a main memory 836, such as a random access memory (RAM), cache and/or other dynamic storage devices, coupled to bus 832 for storing information and instructions to be executed by processor 834. Main memory 836 also may be used for storing temporary variables or other intermediate information during execution of instructions to be executed by processor 834. Such instructions, when stored in storage media accessible to processor 834, render computer system 800 into a special-purpose machine that is customized to perform the operations specified in the instructions.

Computer system 800 further includes a read only memory (ROM) 838 or other static storage device coupled to bus 832 for storing static information and instructions for processor 834. A storage device 840, such as a magnetic disk, optical disk, or USB thumb drive (Flash drive), etc., is provided and coupled to bus 832 for storing information and instructions.

Computer system 800 may be coupled via bus 832 to a display 812, such as a cathode ray tube (CRT) or LCD display (or touch screen), for displaying information to a computer user. An input device 814, including alphanumeric and other keys, is coupled to bus 832 for communicating information and command selections to processor 834. Another type of user input device is cursor control 816, such as a mouse, a trackball, or cursor direction keys for communicating direction information and command selections to processor 834 and for controlling cursor movement on display 812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 800 may include a user interface module to implement a GUI that may be stored in a mass storage device as computer executable program instructions that are executed by the computing device(s). Computer system 800 may further, as described below, implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 834 executing one or more sequences of one or more computer readable program instructions contained in main memory 836. Such instructions may be read into main memory 836 from another storage medium, such as storage device 840. Execution of the sequences of instructions contained in main memory 836 causes processor(s) 834 to perform the process steps described herein. In alternative embodiments, hard-wired circuitry may be used in place of or in combination with software instructions.

Various forms of computer readable storage media may be involved in carrying one or more sequences of one or more computer readable program instructions to processor 834 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 832. Bus 832 carries the data to main memory 836, from which processor 834 retrieves and executes the instructions. The instructions received by main memory 836 may optionally be stored on storage device 840 either before or after execution by processor 834.

Computer system 800 also includes a communication interface 818 coupled to bus 832. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 834 as it is received, and/or stored in storage device 840, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A computerized method, performed by a computing system having one or more hardware computer processors and one or more non-transitory computer readable storage device storing software instructions executable by the computing system to perform the computerized method comprising:
receiving, from a user, a task associated with a workflow configured to interact with a data management system;
determining a plurality of components available in the data management system;
determining relationships between respective components, wherein the relationships indicate valid connections between pairs of respective components;
generating a large language model (LLM) prompt comprising at least some of the task, the components, the relationships between the components, and a request for the LLM to return a list of components and valid connections between components that best satisfy the task;
receiving, from the LLM in response to the LLM prompt, information usable to generate a proposed diagram including a plurality of components and valid connections between respective components,
wherein the plurality of components and valid connections are capable of being compiled into executable instructions for performing the task.

2. The method of claim 1, wherein the prompt further includes, for each of the included components, a type, instance title, and description.

3. The method of claim 1, further comprising:
generating a second LLM prompt including at least some of the task, a list of diagram templates representing common workflows, and a request for the LLM to identify any of the diagram templates that are relevant to the task; and
receiving, from the LLM in response to the second LLM prompt, an indication of at least a first diagram template.

4. The method of claim 2, further comprising:
comparing the first diagram template with the proposed diagram to determine which is optimal for addressing the task.

5. The method of claim 1, wherein the components and relationships are pre-processed and stored in files that are injected into the LLM prompt.

6. The method of claim 1, further comprising:
accessing a list of component properties for each of the plurality of components, wherein the component properties include at least a title, brief description, type, and group component properties;
extracting, from the component properties of each of the components, key component properties including a primary key, title, and brief description;
storing the key component properties;
determining, based at least on the component properties of the plurality of components, valid relationships between respective pairs of components, wherein valid relationships indicate pairs of components that can receive or send data to the other of the pair of components; and
storing the valid relationships.

7. The method of claim 1, wherein the component properties include a priority for each component.

8. The method of claim 1, further comprising:
receiving, from the LLM, indications of a plurality of components, including a component, component description, and an edge from the component to another component.

9. The method of claim 1, wherein each relationship indicates a primary key, from, name, and to properties.

10. The method of claim 1, wherein each of the components is configured to perform a specific task or operation.

11. The method of claim 1, wherein each of the components is represented as a node on a workflow diagram.

12. The method of claim 1, further comprising:
executing a pattern matching module to analyze the user task and identify relevant patterns by extracting entities.

13. The method of claim 1, further comprising:
executing a diagram generation module to create a visual representation of the proposed solution, wherein the generated diagram includes valid connections between components as determined by the relationships.

14. The method of claim 1, further comprising:
executing a next best node suggestion module to provide recommendations for subsequent components to be included in the workflow, based on common and high-priority workflows identified in the data model.

15. The method of claim 1, further comprising:
executing a next best node LLM based module to enhance node suggestions by interacting with the LLM, providing guidance on component selection beyond deterministic relationships.

16. The method of claim 1, further comprising:
executing an edge validity module to verify validity of connections between components in the proposed diagram and flagging any invalid relationships with visual cues.

17. The method of claim 1, further comprising:
executing an edge labeling module to generate descriptive labels for connections between components.

18. The method of claim 1, further comprising:
executing a documentation lookup module to direct users to relevant documentation for components and relationships.

19. The method of claim 1, further comprising:
executing a node auto filling module to propose implementations details for abstract nodes in the proposed diagram.

20. A computerized method, performed by a computing system having one or more hardware computer processors and one or more non-transitory computer readable storage device storing software instructions executable by the computing system to perform the computerized method comprising:
receiving, from a user, a task associated with a workflow configured to interact with a data management system;
generating a large language model (LLM) prompt comprising at least some of the task and a request for the LLM to identify an existing pattern that best satisfies the task;
receiving, from the LLM in response to the LLM prompt, an indication of an existing pattern that includes a plurality of components and connections between respective components; and
providing the identified existing pattern to the user as a proposed solution for the task.
